(19) United States
(12) Patent Application Publication
(10) Pub. No.: US 2015/0124750 A1
(43) Pub. Date: May 7, 2015

(54) SINGLE CARRIER MODULATION FOR UPLINK TRANSMISSIONS

(71) Applicant: QUALCOMM Incorporated, San Diego, CA (US)

(72) Inventors: Sameer Vermani, San Diego, CA (US); Bin Tian, San Diego, CA (US); Lin Yang, San Diego, CA (US)

(21) Appl. No.: 14/533,957

(22) Filed: Nov. 5, 2014

Related U.S. Application Data
(60) Provisional application No. 61/901,359, filed on Nov. 7, 2013.

(51) Int. Cl. H04W 72/04; H04J 1/02

(52) U.S. Cl. CPC H04W 72/04; H04J 1/02
USPC 370/329

(57) ABSTRACT

A method includes generating, at a source device, a data packet for transmission via an Institute of Electrical and Electronics Engineers (IEEE) 802.11 wireless network. The method also includes transmitting at least a portion of the data packet to a destination device according to a single carrier modulation scheme.

### I. CLAIM OF PRIORITY

The present application claims priority from U.S. Provisional Patent Application No. 61/901,359 entitled “SINGLE CARRIER MODULATION FOR UPLINK TRANSMISSIONS,” filed Nov. 7, 2013, the contents of which are incorporated by reference in their entirety.

### II. FIELD

The present disclosure is generally related to communicating data using a single carrier modulation scheme.

### III. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and Internet protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application, that can be used to access the Internet. As such, these wireless telephones can include significant computing capabilities.

Various wireless protocols and standards may be available for use by wireless telephones and other wireless devices. For example, the Institute of Electrical and Electronics Engineers (IEEE) 802.11, commonly referred to as “Wi-Fi,” is a standardized set of wireless local area network (WLAN) communication protocols. In Wi-Fi protocols, uplink transmissions from a source device to a destination device may consume a relatively large amount of power at the source device. Higher transmission powers may reduce a battery life of the source device.

### IV. SUMMARY

Data packets (e.g., waveforms) may be transmitted using a single carrier modulation scheme (e.g., a single carrier frequency division multiple access (SC-FDMA) modulation scheme) to reduce uplink transmission power consumption and to improve (e.g., elongate) battery life at client devices.

To incorporate single carrier modulation schemes for uplink transmissions into Wi-Fi, various physical layer (PHY) parameters and designs may be used. The present disclosure provides single carrier uplink transmission for use with a wireless communication (e.g., IEEE 802.11) system.

In a particular embodiment, a method includes generating, at a source device, a data packet for transmission via an Institute of Electrical and Electronics Engineers (IEEE) 802.11 wireless network. The method also includes transmitting at least a portion of the data packet to a destination device according to a single carrier frequency division multiple access (SC-FDMA) modulation scheme.

In another particular embodiment, an apparatus includes a source device operable to generate a data packet for transmission via an Institute of Electrical and Electronics Engineers (IEEE) 802.11 wireless network. The source device is also operable to transmit at least a portion of the data packet to a destination device according to a single carrier frequency division multiple access (SC-FDMA) modulation scheme.

In another particular embodiment, an apparatus includes means for generating a data packet for transmission via an Institute of Electrical and Electronics Engineers (IEEE) 802.11 wireless network. The apparatus also includes means for transmitting at least a portion of the data packet to a destination device according to a single carrier frequency division multiple access (SC-FDMA) modulation scheme.

In another particular embodiment, a non-transitory computer readable medium includes instructions that, when executed by a processor, cause the processor to generate a data packet for transmission via an Institute of Electrical and Electronics Engineers (IEEE) 802.11 wireless network. The instructions are also executable to cause the processor to transmit at least a portion of the data packet to a destination device according to a single carrier frequency division multiple access (SC-FDMA) modulation scheme.

In another particular embodiment, a method includes generating, at a source device, a data packet for an uplink transmission via an Institute of Electrical and Electronics Engineers (IEEE) 802.11 wireless network. The method also includes transmitting at least a portion of the data packet to a destination device according to a single carrier modulation scheme. Downlink transmissions from the destination device are received at the source device via the IEEE 802.11 wireless network according to a multi-carrier modulation scheme.

In another particular embodiment, an apparatus includes a source device operable to generate a data packet for an uplink transmission via an Institute of Electrical and Electronics Engineers (IEEE) 802.11 wireless network. The source device is also operable to transmit at least a portion of the data packet to a destination device according to a single carrier modulation scheme. Downlink transmissions from the destination device are received at the source device via the IEEE 802.11 wireless network according to a multi-carrier modulation scheme.

In another particular embodiment, an apparatus includes means for generating a data packet for an uplink transmission via an Institute of Electrical and Electronics Engineers (IEEE) 802.11 wireless network. The apparatus also includes means for transmitting at least a portion of the data packet to a destination device according to a single carrier modulation scheme. Downlink transmissions from the destination device are received at the means for generating via the IEEE 802.11 wireless network according to a multi-carrier modulation scheme.

In another particular embodiment, a non-transitory computer readable medium includes instructions that, when executed by a processor, cause the processor to generate a data packet for an uplink transmission via an Institute of Electrical and Electronics Engineers (IEEE) 802.11 wireless network. The instructions are also executable to cause the processor to transmit at least a portion of the data packet to a destination device according to a single carrier modulation scheme. Downlink transmissions from the destination device are received at the processor via the IEEE 802.11 wireless network according to a multi-carrier modulation scheme.

In another particular embodiment, a method includes receiving, at a destination device, at least a portion of a data packet from a source device according to a single carrier frequency division multiple access (SC-FDMA) modulation scheme. The data packet is received via an Institute of Electrical and Electronics Engineers (IEEE) 802.11 wireless network. The method also includes processing the data packet.

In another particular embodiment, an apparatus includes a destination device operable to receive at least a portion of a data packet from a source device according to a single carrier frequency division multiple access (SC-FDMA) modulation scheme. The data packet is received via an Institute of Electrical and Electronics Engineers (IEEE) 802.11 wireless network. The destination device is also operable to process the data packet.

In another particular embodiment, an apparatus includes means for receiving at least a portion of a data packet from a source device according to a single carrier frequency division multiple access (SC-FDMA) modulation scheme. The data packet is received via an Institute of Electrical and Electronics Engineers (IEEE) 802.11 wireless network. The apparatus also includes means for processing the data packet.

In another particular embodiment, a non-transitory computer readable medium includes instructions that, when executed by a processor, cause the processor to receive at least a portion of a data packet from a source device according to a single carrier frequency division multiple access (SC-FDMA) modulation scheme. The data packet is received via an Institute of Electrical and Electronics Engineers (IEEE) 802.11 wireless network. The instructions are also executable to cause the processor to process the data packet.

In another particular embodiment, a method includes receiving, at a destination device, an uplink transmission from a source device. The uplink transmission includes at least a portion of a data packet that is received according to a single carrier modulation scheme. The data packet is received via an Institute of Electrical and Electronics Engineers (IEEE) 802.11 wireless network. The method also includes processing the data packet. Downlink transmissions from the destination device are transmitted via the IEEE 802.11 wireless network according to a multi-carrier modulation scheme.

In another particular embodiment, an apparatus includes a destination device operable to receive an uplink transmission from a source device. The uplink transmission includes at least a portion of a data packet that is received according to a single carrier modulation scheme. The data packet is received via an Institute of Electrical and Electronics Engineers (IEEE) 802.11 wireless network. The destination device is also operable to process the data packet. Downlink transmissions from the destination device are transmitted via the IEEE 802.11 wireless network according to a multi-carrier modulation scheme.

In another particular embodiment, an apparatus includes means for receiving an uplink transmission from a source device. The uplink transmission includes at least a portion of a data packet that is received according to a single carrier modulation scheme. The data packet is received via an Institute of Electrical and Electronics Engineers (IEEE) 802.11 wireless network. The apparatus also includes means for processing the data packet. Downlink transmissions from the means for processing are transmitted via the IEEE 802.11 wireless network according to a multi-carrier modulation scheme.

In another particular embodiment, a non-transitory computer readable medium includes instructions that, when executed by a processor, cause the processor to receive an uplink transmission from a source device. The uplink transmission includes at least a portion of a data packet that is received according to a single carrier modulation scheme. The data packet is received via an Institute of Electrical and Electronics Engineers (IEEE) 802.11 wireless network. The instructions are also executable to cause the processor to process the data packet. Downlink transmissions from the processor are transmitted via the IEEE 802.11 wireless network according to a multi-carrier modulation scheme.

One particular advantage provided by at least one of the disclosed embodiments is reduced power consumption and an improved peak-to-average power ratio (PAPR) during uplink transmissions by implementing single carrier modulation schemes into uplink transmissions over an Institute of Electrical and Electronics Engineers (IEEE) 802.11 wireless network. Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a block diagram of a particular illustrative embodiment of a system that includes a device operable to transmit data packets over a wireless network using a single carrier modulation scheme;

FIG. 2 depicts particular illustrative embodiments of sub-carrier mapping used in a single carrier modulation scheme;

FIG. 3 depicts particular illustrative embodiments of data packets that are generated according to a single carrier modulation scheme;

FIG. 4 is a particular embodiment of a source device and a destination device according to a single carrier modulation scheme;

FIG. 5 depicts particular embodiments of methods for communicating data over an Institute of Electrical and Electronics Engineers (IEEE) 802.11 wireless network using a single carrier modulation scheme;

FIG. 6 depicts other particular embodiments of methods for communicating data over an IEEE 802.11 wireless network using a single carrier modulation scheme; and

FIG. 7 is a diagram of a wireless device that is operable to support various embodiments of one or more methods, systems, apparatuses, and/or computer-readable media disclosed herein.

### VI. DETAILED DESCRIPTION

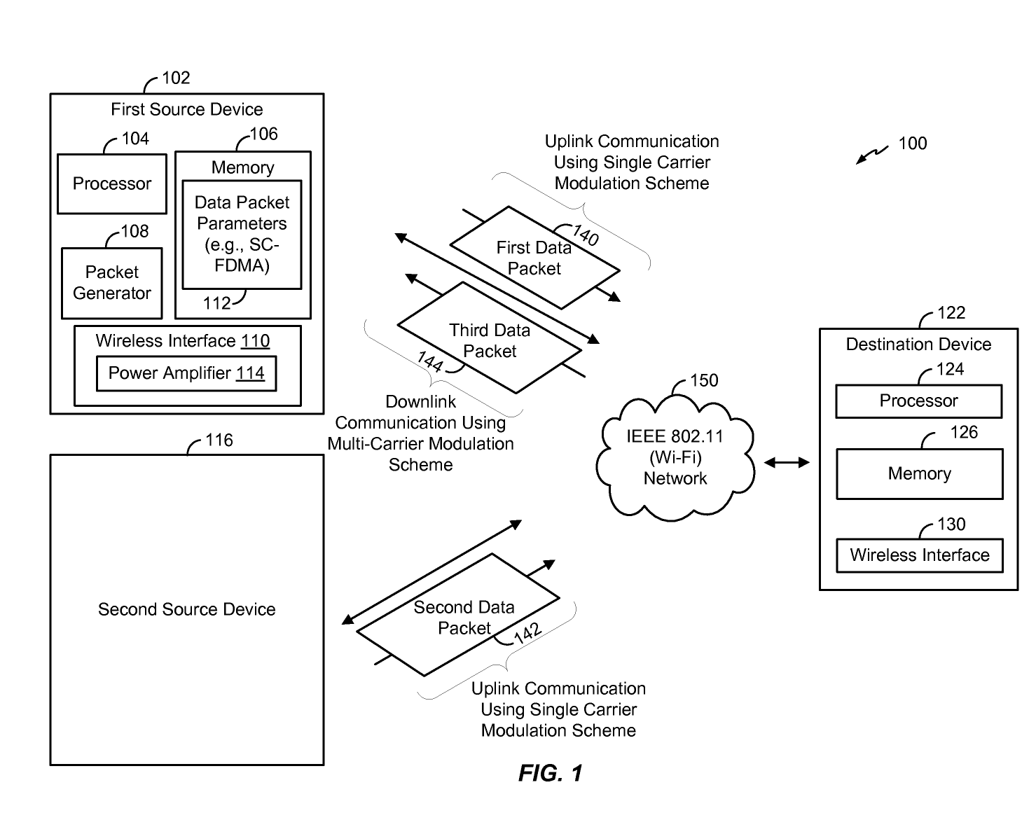

Referring to FIG. 1, a particular illustrative embodiment of a system 100 that includes a device operable to transmit data packets over a wireless network using a single carrier modulation scheme is shown. The system 100 includes a first source device 102 and a second source device 116 that are configured to wirelessly communicate with a destination device 122 via a wireless network 150.

In a particular embodiment, the wireless network 150 is an Institute of Electrical and Electronics Engineers (IEEE) 802.11-type wireless network (e.g., a Wi-Fi network). For example, the wireless network 150 may operate in accordance with an IEEE 802.11 standard. In an illustrative embodiment, the wireless network 150 is an 802.11 high efficiency WLAN (HEW) network. In a particular embodiment, the wireless network 150 supports single and/or multiple access communication. For example, the wireless network 150 may support an uplink transmission of a first data packet 140 (e.g., a first waveform) from the first source device 102 to the destination device 122. In another example, the wireless network 150 may support uplink transmissions of multiple data packets (e.g., the first data packet 140 and a second data packet 142) from multiple source devices (e.g., the first and second source devices 102, 116) to the destination device 122.

The wireless network 150 may support uplink transmissions according to a single carrier modulation scheme from source devices 102, 116 to the destination device 122. For example, the first data packet 140 and the second data packet 142 may be transmitted according to a single carrier frequency division multiple access (SC-FDMA) modulation scheme, as further described herein. The wireless network 150 may also support downlink transmissions from the destination device 122 to the source devices 102, 116 according to a multi-carrier modulation scheme. For example, a third data packet 144 may be transmitted from the destination device 122 to the first source device 102 according to a multi-carrier modulation scheme (e.g., OFDM). As used herein, the wireless network 150 may support transmissions according to one or more of the IEEE 802.11a, 802.11n, or 802.11ac standards.

In the illustrative embodiment, the first and second data packets 140, 142 are illustrative of uplink transmissions. For example, the source devices 102, 116 may be mobile phones configured to generate and transmit the first and second data packets 140, 142, and the destination device 122 may be an access point (AP) or other device (e.g., coordinator of a basic service set (BSS)) configured to receive the first and second data packets 140, 142 from the source devices 102, 116. The first source device 102 includes a processor 104 (e.g., a central processing unit (CPU), a digital signal processor (DSP), a network processing unit (NPU), etc.), a memory 106 (e.g., a random access memory (RAM), a read-only memory (ROM), etc.), and a wireless interface 110 configured to send and receive data via the wireless network 150. In a particular embodiment, the wireless interface 110 may include a power amplifier 114 that is configured to amplify components of the first data packet 140 prior to transmission. In a particular embodiment, the power amplifier 114 may be a non-linear power amplifier (e.g., a class “C” power amplifier or a class “E” power amplifier). The memory 106 may store data packet parameters 112 (e.g., SC-FDMA parameters including sub-carrier parameters, modulation symbol mapping parameters, etc.) used by a packet generator 108 to generate the first data packet 140. In a particular embodiment, the packet generator 108 is configured to generate single access packets as well as multiple access packets.

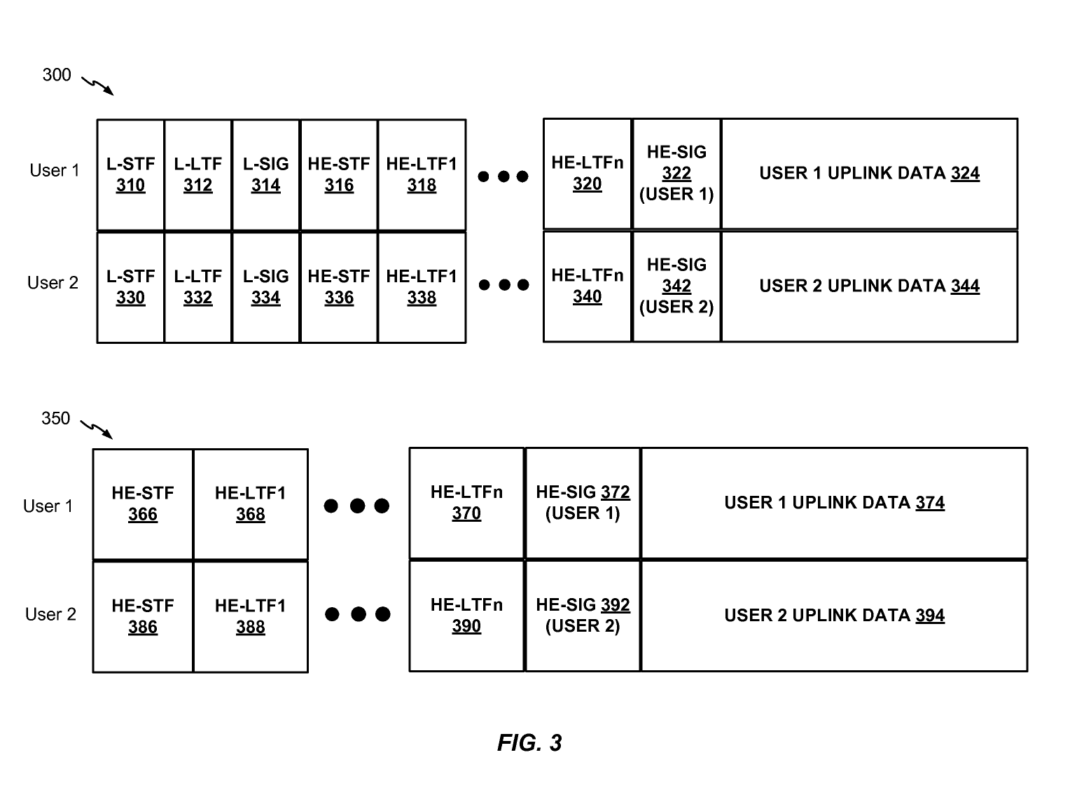

As used herein, a “sub-carrier” may represent a frequency or set of frequencies (e.g., a frequency range) of a signal that may be modulated for communication of data. A sub-carrier may alternately be referred to as a tone. A “sub-carrier” may thus be a frequency-domain unit, and a packet may span multiple sub-carriers. In contrast to sub-carriers, a “symbol” may be a time-domain unit, and a packet may span (e.g., include) multiple symbols, each symbol having a particular duration. A wireless packet may thus be visualized as a two-dimensional structure that spans a frequency range (e.g., sub-carriers) and a time period (e.g., symbols), as illustrated with respect to FIG. 3.

As an example, a wireless device may transmit a packet via a 20 megahertz (MHz) wireless channel (e.g., a channel having a 20 MHz frequency band). A subset of sub-carriers may be considered “useable” and the remaining sub-carriers may be considered “unusable” (e.g., may be guard sub-carriers, direct current (DC) sub-carriers, etc.). For example, to generate an SC-FDMA waveform for the 20 MHz wireless channel with 52 data sub-carriers and 4 pilot sub-carriers, the wireless device may apply (e.g., perform) a 52-point Discrete Fourier Transform (DFT) on time-domain data to transform the time-domain data into frequency-domain data. The wireless device may map the frequency-domain data to the 52 data sub-carriers. The wireless device may also insert the 4 pilot sub-carriers, 1 DC sub-carrier, and 7 guard sub-carriers into the SC-FDMA waveform to generate an SC-FDMA waveform with 64 sub-carriers in the frequency-domain. It should be noted that the aforementioned channel frequency bands, transforms, and sub-carrier plans are for example. In alternate embodiments, different channel frequency bands (e.g., 40 MHz, 80 MHz, etc.), different transforms (e.g., 108-point DFT, 234-point DFT, etc.), and/or different sub-carrier plans may be used.

In a particular embodiment, the data packet parameters 112 may be used by the packet generator 108 during generation of the first data packet 140 to determine sub-carrier allocations for data to be transmitted, modulation symbol mapping parameters, and/or code rates (e.g., binary phase shift keying (BPSK) rates, quadrature phase shift keying (QPSK) rates, etc.). The second source device 116 may include similar components as the first source device 102, and the second source device 116 may operate in a substantially similar manner as the first source device 102 to generate the second data packet 142.

The packet generator 108 may generate at least a portion of the first data packet 140 for transmission via the wireless network 150 according to a single carrier modulation scheme using the data packet parameters 112. As explained with respect to FIG. 3, a data field portion of the first data packet 140 may be generated for transmission according to the single carrier modulation scheme. In a particular embodiment, the single carrier modulation scheme may correspond to an SC-FDMA modulation scheme. For example, the packet generator 108 may perform a transform operation on a first plurality of data symbols of the first data packet 140 to generate transform coefficients corresponding to the first plurality of data symbols.

In a particular embodiment, the packet generator 108 may perform a DFT operation on the first plurality of data symbols to generate first DFT coefficients corresponding to the first plurality of data symbols. For example, the packet generator 108 may transform the first plurality of data symbols from time-domain data symbols to frequency-domain data symbols. A first sub-carrier associated with the first DFT coefficients may carry each frequency-domain data symbol for a fraction (e.g., 1/N) of a symbol period. For example, each frequency-domain symbol may be transmitted over the first sub-carrier in series at an increased transmission rate (e.g., N times the transmission rate) to achieve SC-FDMA modulation.

In a substantially similar manner, one or more additional source devices may also generate one or more additional data packets for transmission via the wireless network 150 according to the single carrier modulation scheme (e.g., the SC-FDMA modulation scheme). In the illustrative embodiment, the second source device 116 may perform a DFT operation on a second plurality of data symbols of the second data packet 142 to generate second DFT coefficients corresponding to the second plurality of data symbols. A second sub-carrier associated with the second DFT coefficients may carry each frequency-domain data symbol in series at the increased transmission rate to achieve SC-FDMA modulation.

The wireless interface 110 may transmit the first data packet 140 to the destination device 122 via the wireless network 150, and the second source device 116 may transmit the second data packet 142 to the destination device 122 via the wireless network 150. At least a portion of the first data packet 140 may be transmitted over the first sub-carrier, and at least a portion of the second data packet 142 may be transmitted over the second sub-carrier.

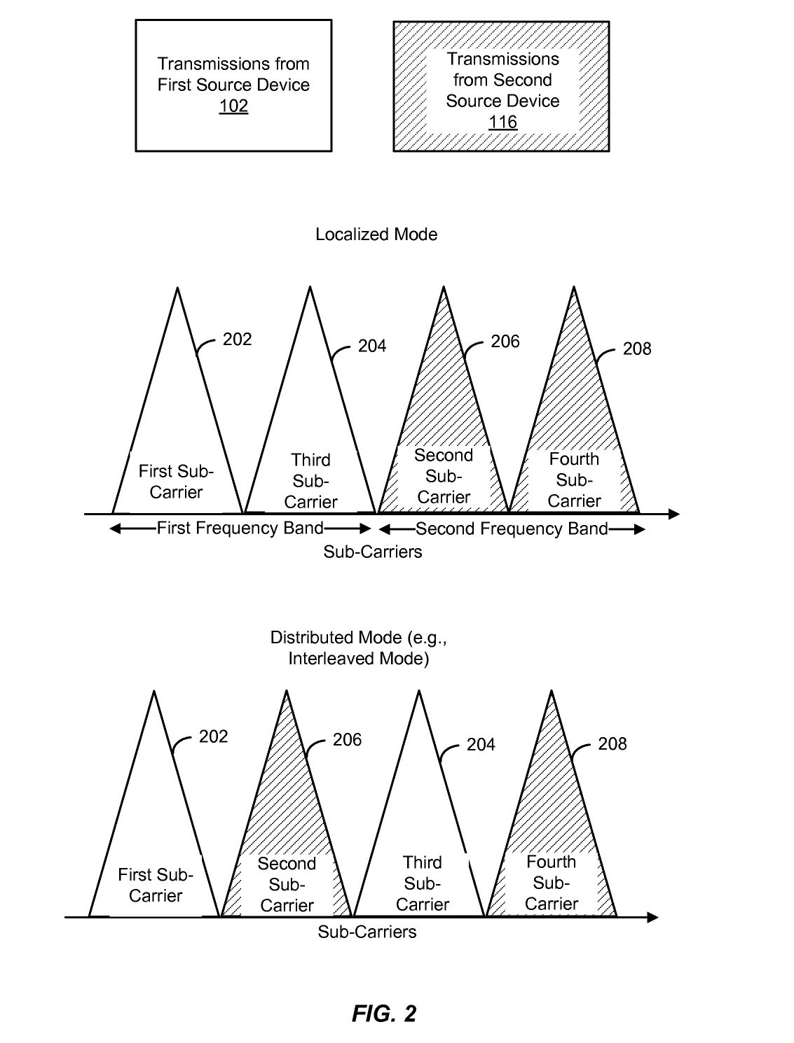

In a particular embodiment, transmissions from the first source device 102 (e.g., the first data packet 140) may be localized within a particular (continuous) frequency band, and transmissions from the second source device 116 (e.g., the second data packet 142) may be localized within other frequency bands that do not overlap the particular frequency band. For example, referring to FIG. 2, particular illustrative embodiments of sub-carrier mapping used in a single carrier modulation scheme are shown. Transmissions from the first source device 102 of FIG. 1 (e.g., the first data packet 140) are referenced with respect to a solid (white) pattern, and transmissions from the second source device 116 of FIG. 1 (e.g., the second data packet 142) are referenced with respect to a striped pattern.

In a localized mode, transmissions from the first source device 102 may be localized within a first frequency band. For example, the first frequency band may include a first sub-carrier 202 (e.g., the first sub-carrier of FIG. 1 used to transmit the first plurality of data symbols according to the SC-FDMA modulation scheme) and a third sub-carrier 204 (e.g., another sub-carrier used to transmit data from the first source device 102). Transmissions from the second source device 116 may be localized within a second frequency band. For example, the second frequency band may include a second sub-carrier 206 (e.g., the second sub-carrier of FIG. 1 used to transmit the second plurality of data symbols according to the SC-FDMA modulation scheme) and a fourth sub-carrier 208 (e.g., another sub-carrier used to transmit data from the second source device 116). The first and second frequency bands may be continuous non-overlapping frequency bands.

Localizing transmissions from the first source device 102 in a continuous frequency band (e.g., the first frequency band) and localizing transmissions from the second source device 116 in a non-overlapping continuous frequency band (e.g., the second frequency band) may improve throughput of the system 100 of FIG. 1. For example, the localized mode may enable the first frequency band to be assigned to the first source device 102 and the second frequency band to be assigned to the second source device 116.

In another particular embodiment, transmissions from the first source device 102 and transmissions from the second source device 116 may be distributed. For example, the distributed mode depicted in FIG. 2 illustrates that transmissions from the first source device 102 and transmissions from the second source device 116 may be distributed (e.g., interleaved) at non-consecutive sub-carriers. Interleaving transmissions from the first and second source devices 102, 116 over available bandwidth may result in unused sub-carriers having zero amplitude.

Interleaving sub-carriers may improve (e.g., reduce) a peak-to-average power ratio (PAPR) of transmissions as compared to the localized mode. For example, absent pulse shape filtering, interleaving sub-carriers may reduce a PAPR as compared to localizing sub-carriers. As a non-limiting example, the PAPR of an interleaved SC-FDMA modulation scheme using QPSK is approximately 10 decibels (dBs) lower than a PAPR of an orthogonal frequency division multiplexing (OFDM) modulation scheme, whereas the PAPR of a localized SC-FDMA modulation scheme using QPSK is approximately 3 dBs lower than the PAPR of an OFDM modulation scheme. Using 16 quadrature amplitude modulation (QAM), the PAPR of interleaved SC-FDMA modulation scheme and the localized SC-FDMA modulation scheme is approximately 7 dB and 2 dB lower than the PAPR of an OFDM modulation scheme, respectively.

In generating the first data packet 140, the packet generator 108 of FIG. 1 may generate a preamble to indicate that the first data packet 140 is utilizing a single carrier modulation scheme during the uplink transmission. For example, each data packet 140, 142 may include a preamble to indicate that the uplink transmission is utilizing a single carrier modulation scheme (e.g., the SC-FDMA modulation scheme). Referring to FIG. 3, particular illustrative embodiments 300, 350 of data packets that are generated according to a single carrier modulation scheme are shown. The first embodiment 300 may correspond to a mixed-mode (MM) uplink data packet format, and the second embodiment 350 may correspond to a green field (GF) uplink data packet format. Each embodiment 300, 350 may include transmission data from multiple users (e.g., User 1 and User 2). In a particular embodiment, User 1 may be associated with the first source device 102 of FIG. 1, and User 2 may be associated with the second source device 116 of FIG. 1.

The first embodiment 300 includes a legacy preamble. For example, the first embodiment 300 may include a first legacy short training field (L-STF) 310, a first legacy long training field (L-LTF) 312, and a first legacy signal field (L-SIG) 314. The first L-STF 310, the first L-LTF 312, and the first L-SIG 314 may be associated with User 1. In addition, the first embodiment 300 includes a second L-STF 330, a second L-LTF 332, and a second L-SIG 334. The second L-STF 330, the second L-LTF 332, and the second L-SIG 312 may be associated with User 2. The legacy preamble may indicate to a destination device (e.g., the destination device 122 of FIG. 1) that at least a portion of the first embodiment 300 is transmitted according to an SC-FDMA mode. For example, an SC-FDMA mode indication may be transmitted via the legacy preamble by populating the SC-FDMA mode indication in the L-STF 310, 330, the L-LTF 312, 332, and/or the L-SIG 314, 334. Alternatively, the SC-FDMA mode indication may be transmitted by a preceding “trigger” frame. For example, a trigger frame (e.g., a data packet) may be transmitted to the destination device 122 prior to the data packet illustrated by the first embodiment 300. The trigger frame may include the SC-FDMA mode indication to indicate that at least a portion of the data packet illustrated by the first embodiment 300 is transmitted according to an SC-FDMA mode. The legacy preamble may be transmitted according to an OFDM modulation scheme to prevent additional source devices accessing a wireless network (e.g., the wireless network 150 of FIG. 1) from transmitting on carrier frequencies associated with the data packet (e.g., the data packet illustrated by the first embodiment 300).

The first embodiment 300 also includes a high efficiency (HE) preamble. For example, the first embodiment 300 may include a first HE short training field (HE-STF) 316, a first HE long training field (HE-LTF1) 318, an N^{th} HE long training field (HE-LTFn) 320, and a first HE signal field (HE-SIG) 322. The first HE-STF 316, the first HE-LTF1 318, the N^{th} HE-LTFn 320, and the first HE-SIG 322 may be associated with User 1. Additionally, User 2 may transmit HE preamble data (e.g., HE-STF 336, HE-LTF1 338, HE-LTFn 340, HE-SIG 342). The HE preamble data may be transmitted according to the SC-FDMA mode indicated by the SC-FDMA mode indication in the legacy preamble. Although the first embodiment 300 includes the HE signal fields (HE-SIG) 322, 342, in other embodiments, data packets may not include the HE signal fields (HE-SIG) 322, 342. In a particular embodiment, data packets may include HE-SIG symbols between the legacy signal fields (L-SIG) 314, 334 and the HE short training field (HE-STF) 316, 336. The HE-SIG symbols may indicate to a HEW device whether the packet is an 802.11a packet or an 802.11ac packet (e.g., robust classification). The HE-SIG symbols may also indicate whether the packet is an up-link packet and/or a BSS associated with the packet for medium reuse.

The first embodiment 300 may also include a first data field 324 and a second data field 344. The first data field 324 may correspond to uplink data symbols that are associated with User 1, and the second data field 344 may correspond to uplink data symbols that are associated with User 2. The data symbols in the first data field 324 and the second data field 344 may be transmitted according to an SC-FDMA modulation scheme, as described with respect to FIG. 1.

The second embodiment 350 includes a high efficiency (HE) preamble. For example, the second embodiment 350 may include a first HE-STF 366, a first HE-LTF1 368, an N^{th} HE-LTFn 370, and a first HE-SIG 372. The first HE-STF 366, the first HE-LTF1 368, the N^{th} HE-LTFn 370, and the first HE-SIG 372 may be associated with User 1. Additionally, User 2 may transmit HE preamble data (e.g., HE-STF 386, HE-LTF1 388, HE-LTFn 390, HE-SIG 392). The HE preamble data may be transmitted according to an SC-FDMA mode. Alternatively, a trigger frame (e.g., a data packet) may be transmitted prior to the data packet illustrated by the second embodiment 350. The trigger frame may include an SC-FDMA mode indication to indicate that at least a portion of the data packet illustrated by the second embodiment 350 is transmitted according to an SC-FDMA mode.

The second embodiment 350 may also include a first data field 374 and a second data field 394. The first data field 374 may correspond to uplink data symbols that are associated with User 1, and the second data field 394 may correspond to uplink data symbols that are associated with User 2. The data symbols in the first data field 374 and the second data field 394 may be transmitted according to an SC-FDMA modulation scheme, as described with respect to FIG. 1.

The MM uplink data packet format (e.g., the first embodiment 300) may include a legacy preamble (e.g., a preamble transmitted according to an OFDM modulation scheme) to enable other source devices that are not compatible with a single carrier modulation scheme (e.g., legacy devices) to identify that a particular channel (e.g., a 20 MHz channel, a 40 MHz channel, an 80 MHz channel, etc.) is being utilized by the first source device 102 and the second source device 116 and to delay transmissions on the particular channel for a particular duration (e.g., the duration of the data packet). The GF uplink data packet format (e.g., the second embodiment 350) may be used when other source devices are compatible with the single carrier modulation scheme and readily comprehend (i.e., can detect and process) the HE preamble.

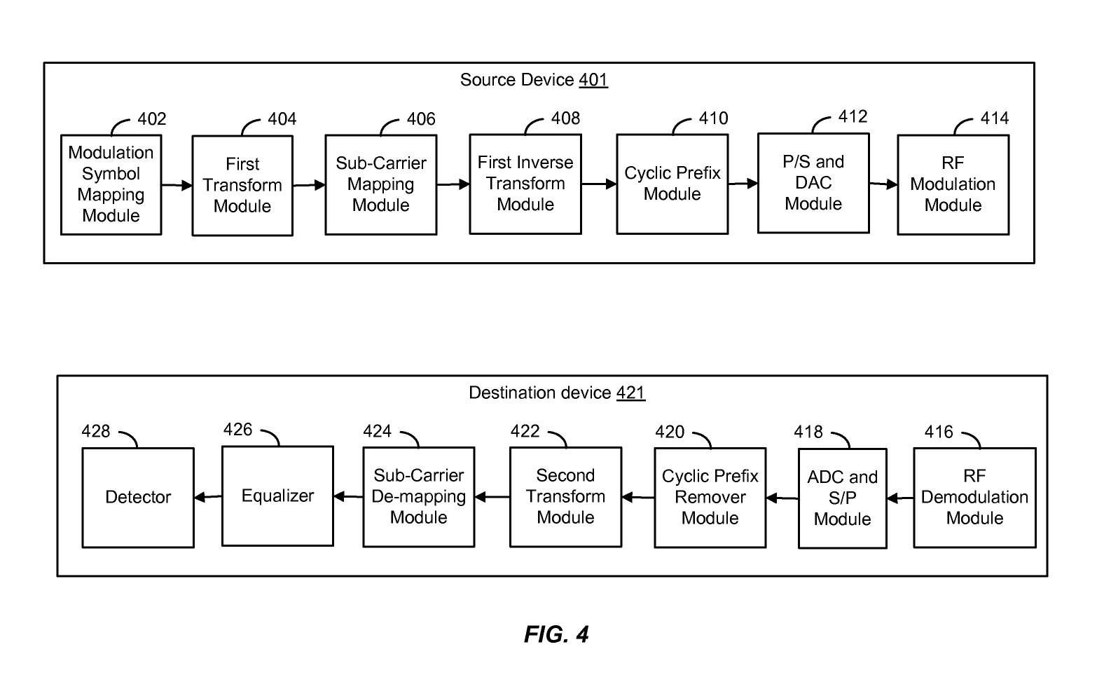

Referring back to FIG. 1, the destination device 122 may include a second processor 124, a second memory 126, and a second wireless interface 130. The second wireless interface 130 may be operable to receive the first data packet 140 and the second data packet 142 from the first and second source devices 102, 116, respectively. For example, second wireless interface 130 may be operable to receive the data packets 140, 142 via the wireless network 150. As described with respect to FIG. 4, the destination device 122 may be operable to process the data packets 140, 142 according to the single carrier modulation scheme.

The system 100 of FIG. 1 may reduce power consumption for uplink transmissions and improve battery life at the first and second source devices 112, 116 by transmitting the first and second data packets 140, 142, respectively, according to a single carrier modulation scheme (e.g., the SC-FDMA modulation scheme). For example, SC-FDMA uplink transmissions may have reduced PAPRs compared to orthogonal frequency division multiple access (OFDMA) and OFDM uplink transmissions because symbols in an SC-FDMA uplink transmissions are pre-processed using a DFT operation.

Uplink transmissions using the single carrier modulation scheme as described with respect to the system 100 may also reduce design constraints on the power amplifier 114. A lower PAPR may improve efficiency of the power amplifier 114 at the wireless interface 110 (e.g., the transmitter). For example, power efficiency is relatively high when the power amplifier 114 operates at saturation. A lower PAPR allows operation of the power amplifier 114 close to saturation, while a higher PAPR may require an operating point of the power amplifier 114 to be “backed off” to lower signal distortion, thereby lowering efficiency. A single carrier signal may be amplified by a non-linear power amplifier (e.g., a class “C” power amplifier or a class “E” power amplifier) with reduced distortion as compared to distortion associated with a linear amplifier. Non-linear power amplifiers may be more efficient than linear power amplifiers in terms of direct-current (DC) power consumption. For example, non-linear power amplifiers may have reduced power consumption for a given output, which may result in increased battery life. As a non-limiting example, transmitting the data packets 140, 142 to the destination device 122 using a single carrier modulation scheme as opposed to using an OFDM scheme may reduce power consumption at the source devices 102, 116 by up to forty-eight percent.

Referring to FIG. 4, a particular embodiment of a source device 401 and a destination device 421 according to a single carrier modulation scheme is shown. The source device 401 may correspond to the first source device 102 of FIG. 1 or the second source device 116 of FIG. 1. The destination device 421 may correspond to the destination device 122 of FIG. 1. The source device 401 may include a modulation symbol mapping module 402, a first transform module 404, a sub-carrier mapping module 406, a first inverse transform module 408, a cyclic prefix module 410, a parallel-to-serial (P/S) converter and digital-to-analog converter (DAC) module 412, and a radio frequency (RF) modulation module 414.

The modulation symbol mapping module 402 may be configured to transform data symbols (e.g., input binary bits) into a set of complex numbers that correspond to a modulation format. For example, the complex numbers may correspond to a binary phase shift keying (BPSK) format, a quadrature phase shift keying (QPSK) format, a 16 quadrature amplitude modulation (QAM) format, a 64-QAM format, or any combination thereof. The modulation format may be based on the signal-to-noise levels and decoding capabilities of a receiver (e.g., the destination device 122 of FIG. 1). The set of complex numbers may be provided to the first transform module 404.

The first transform module 404 may group the set of complex numbers into a block of N data symbols, where N is equal to 52 for a 20 MHz SC-FDMA waveform, 108 for a 40 MHz SC-FDMA waveform, or 234 for an 80 MHz SC-FDMA waveform. The first transform module 404 may be configured to perform an N-point transform operation on the data symbols to convert the signals from the time-domain to the frequency-domain. For example, the first transform module 404 may perform a 52-point transform operation for the 20 MHz SC-FDMA waveform, a 108-point transform operation for the 40 MHz SC-FDMA waveform, a 234-point transform operation for the 80 MHz SC-FDMA waveform, etc. In a particular embodiment, the first transform module 404 may be a DFT transform module and may perform an N-point DFT transform operation on the symbols to convert the data symbols from the time-domain to the frequency-domain. The frequency-domain data symbols may be provided to the sub-carrier mapping module 406.

The sub-carrier mapping module 406 may be configured to map the frequency-domain data symbols to a subset of N sub-carriers. The sub-carrier mapping module 406 may assign DFT complex values (e.g., the frequency-domain symbols) as amplitudes for selected sub-carriers (e.g., the N sub-carriers). The SC-FDMA waveform may also include pilot sub-carriers, DC sub-carriers, and guard sub-carriers. For example, the SC-FDMA waveform may include a total of M sub-carriers, where M>N. In a particular embodiment, the SC-FDMA waveform may be a 20 MHz waveform having 64 sub-carriers (e.g., M=64). In this particular embodiment, 52 sub-carriers may be carry the frequency-domain data symbols (e.g., N=52), 4 sub-carriers may be pilot sub-carriers, 1 sub-carrier may be a DC sub-carrier, and 7 sub-carriers may be guard sub-carriers. The sub-carrier mapping module 406 may map the frequency-domain symbols according to a distributed mode or according to a localized mode, as described with respect to FIG. 2. The first inverse transform module 408 may perform an M-point inverse transform operation on the M sub-carriers to generate time-domain samples of the M subcarriers. For example, the first inverse transform module 408 may perform an inverse DFT (IDFT) transform operation on the M sub-carriers to generate time-domain samples of the M subcarriers. The time-domain samples may be provided to the cyclic prefix module 410.

The cyclic prefix module 410 may be configured to duplicate a portion of the time-domain samples to generate a cyclic prefix. The length of the cyclic prefix may be based on a channel delay spread and may be longer than a length of the channel response. The P/S converter and DAC module 412 may be configured to serialize the time-domain samples and convert the serialized time-domain samples from the digital domain to the analog domain (e.g., analog signals). The RF modulation module 414 may be configured to modulate the analog signals to a radio frequency. For example, the RF modulation module 414 may output the first data packet 140 of FIG. 1. In a particular embodiment, each module 402-414 may include instructions that are executable by the processor 104 of FIG. 1, the packet generator 108 of FIG. 1, or any combination thereof. In another particular embodiment, each module 402-414 may include dedicated or shared hardware (e.g., circuitry), a processor that is operable to perform functions, or a combination thereof.

The destination device 421 may be configured to perform inverse operations of the packet generator 108 (e.g., the transmitter) in reverse order. For example, the destination device 421 may include an RF demodulation module 416, an analog-to-digital converter (ADC) and serial-to-parallel (S/P) converter module 418, a cyclic prefix remover module 420, a second transform module 422, a sub-carrier de-mapping module 424, an equalizer 426, and a detector 428.

The RF demodulation module 416 may receive the output of the RF modulation module 414 (e.g., receive the first data packet 140) and may be configured to demodulate the radio frequency signals to a baseband frequency. The ADC and S/P converter module 418 may be configured to convert the baseband signals from the analog domain to the digital domain and to parallelize the baseband signals. The cyclic prefix remover module 420 may be configured to remove the cyclic prefix generated by the cyclic prefix module 410. The second transform module 422 may be configured to perform an N-point transform operation on the remaining time-domain symbols to convert the signals from the time-domain to the frequency-domain. For example, the second transform module 422 may perform a 64-point transform operation, a 256-point transform operation, a 1024-point transform operation, etc. In a particular embodiment, the second transform module 422 may be a DFT transform module and may perform an N-point DFT transform operation on the symbols to convert the symbols from the time-domain to the frequency-domain. The frequency-domain symbols may be provided to the sub-carrier de-mapping module 424. The sub-carrier de-mapping module 424 may be configured to assign the frequency-domain symbols (e.g., DFT complex values) as amplitudes and phases for selected sub-carriers. The equalizer 426 may be configured to perform an equalization operation on amplitudes, and the detector 428 may be configured to detect the data symbols.

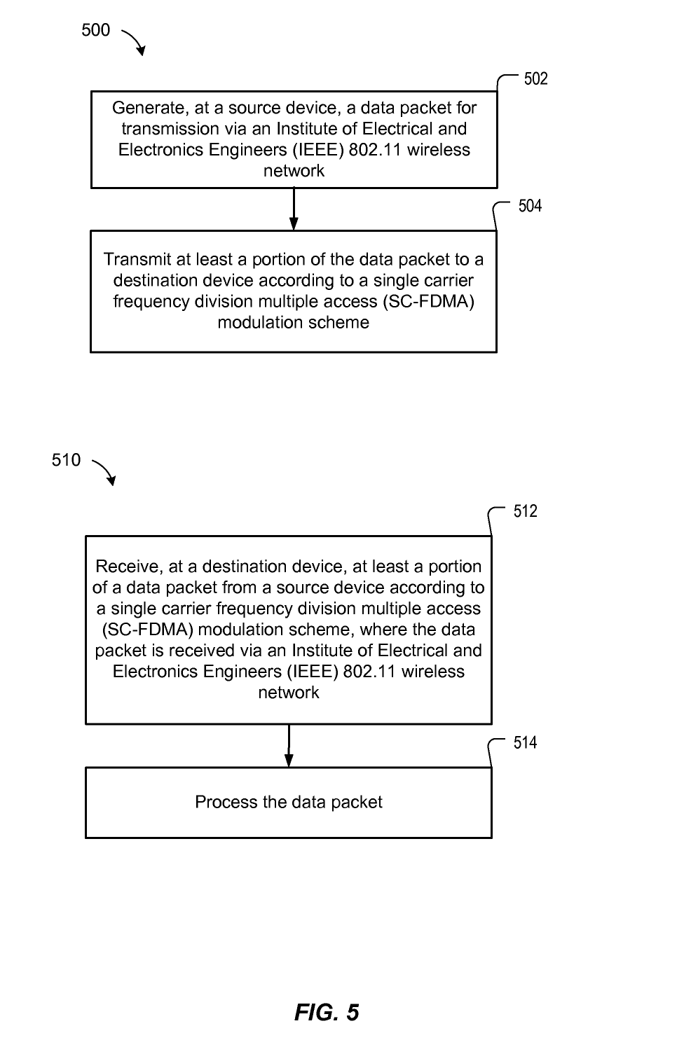

Referring to FIG. 5, particular embodiments of methods 500, 510 for communicating data over an IEEE 802.11 wireless network using a single carrier modulation scheme are shown. The first method 500 may be performed using the first source device 102 of FIG. 1, the second source device 116 of FIG. 1, the source device 401 of FIG. 4, or any combination thereof. The second method 510 may be performed using the destination device 122 of FIG. 1, the destination device 421 of FIG. 4, or any combination thereof.

The first method 500 includes generating, at a source device, a data packet for transmission via an IEEE 802.11 wireless network, at 502. For example, in FIG. 1, the first source device 102 may generate the first data packet 140 for transmission via the wireless network 150. The first data packet 140 may be generated in a similar manner as described with respect to the source device 401 of FIG. 4. At least a portion of the data packet may be transmitted to a destination device according to a SC-FDMA modulation scheme, at 504. For example, in FIG. 1, the first source device 102 may transmit a data field portion (e.g., the data field 340 of FIG. 3) of the first data packet 140 according to the SC-FDMA modulation scheme.

The second method 510 includes receiving, at a destination device, at least a portion of a data packet from a source device according to a SC-FDMA modulation scheme, at 512. For example, in FIG. 1, the destination device 122 may receive a data field portion (e.g., the data field 340 of FIG. 3) of the first data packet 140 from the first source device 102 according the SC-FDMA modulation scheme. The first data packet 140 may be received with the wireless network 150 (e.g., an IEEE wireless network). The data packet may be processed, at 514. For example, in FIG. 1, the destination device 122 may process the first data packet 140. In a particular embodiment, the destination device 122 may process the first data packet 140 in a similar manner as described with respect to the destination device 421 of FIG. 4.

The methods 500, 510 of FIG. 5 may reduce power consumption for uplink transmissions and improve battery life at client devices by transmitting data packets according to a single carrier modulation scheme (e.g., the SC-FDMA modulation scheme). For example, SC-FDMA uplink transmissions may have reduced PAPRs as compared to OFDMA and OFDM uplink transmissions because symbols in an SC-FDMA uplink transmissions are pre-processed using a DFT operation. Uplink transmissions using the single carrier modulation scheme as described with respect to the methods 500, 510 of FIG. 5 may also reduce design constraints on power amplifiers, such as the power amplifier 114 of FIG. 1.

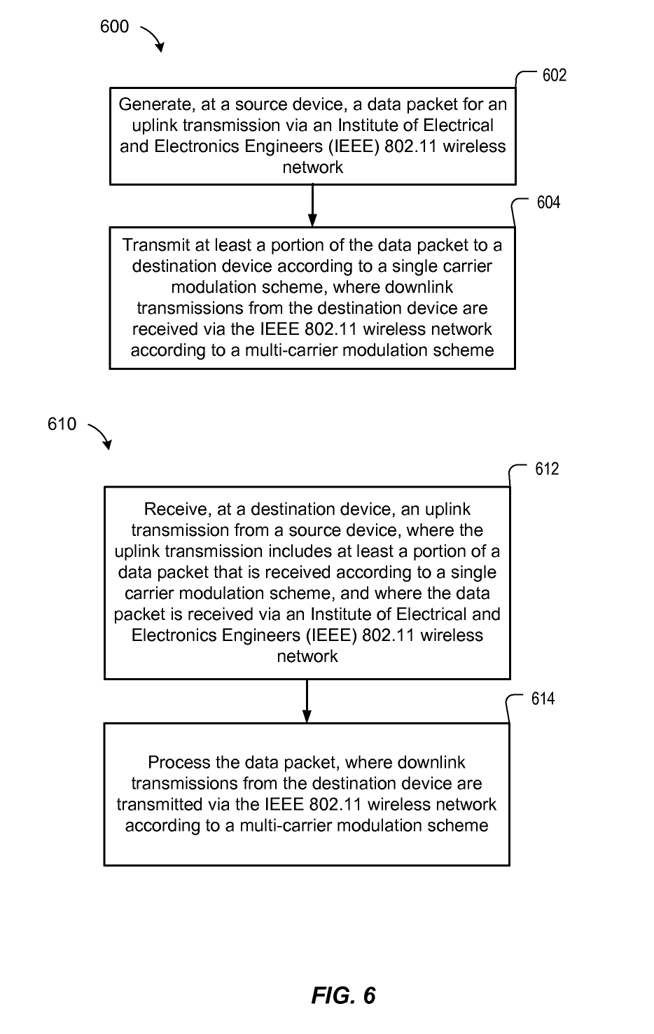

Referring to FIG. 6, other particular embodiments of methods 600, 610 for communicating data over an IEEE 802.11 wireless network using a single carrier modulation scheme are shown. The first method 600 may be performed using the first source device 102 of FIG. 1, the second source device 116 of FIG. 1, the source device 401 of FIG. 4, or any combination thereof. The second method 610 may be performed using the destination device 122 of FIG. 1, the destination device 421 of FIG. 4, or any combination thereof.

The first method 600 includes generating, at a source device, a data packet for uplink transmission via an IEEE 802.11 wireless network, at 602. For example, in FIG. 1, the first source device 102 may generate the first data packet 140 for uplink transmission via the wireless network 150. The first data packet 140 may be generated in a similar manner as described with respect to the source device 401 of FIG. 4. At least a portion of the data packet may be transmitted to a destination device according to a single carrier modulation scheme, at 604. For example, in FIG. 1, the first source device 102 may transmit a data field portion (e.g., the data field 340 of FIG. 3) of the first data packet 140 according to a single carrier modulation scheme. Downlink transmissions from the destination device 122 may be received via the wireless network according to a multi-carrier modulation scheme. For example, the third data packet 144 may be transmitted from the destination device 122 to the first source device 102 according to a multi-carrier modulation scheme, such as OFDM.

The second method 610 includes receiving, at a destination device, an uplink transmission from a source device, at 612. For example, in FIG. 1, the destination device 122 may receive the first data packet 140 from the first source device 102. At least a portion (e.g., the data field 340 of FIG. 3) of the first data packet 140 may be received according a single carrier modulation scheme. The first data packet 140 may be received with the wireless network 150 (e.g., an IEEE wireless network). The data packet may be processed, at 614. For example, in FIG. 1, the destination device 122 may process the first data packet 140. In a particular embodiment, the destination device 122 may process the first data packet 140 in a similar manner as described with respect to the destination device 421 of FIG. 4. Downlink transmissions from the destination device 122 may be transmitted via the wireless network according to a multi-carrier modulation scheme. For example, the third data packet 144 may be transmitted from the destination device 122 to the first source device 102 according to a multi-carrier modulation scheme (e.g., OFDM).

The methods 600, 610 of FIG. 6 may reduce power consumption for uplink transmissions and improve battery life at client devices by transmitting data packets according to a single carrier modulation scheme (e.g., the SC-FDMA modulation scheme). For example, SC-FDMA uplink transmissions may have reduced PAPRs as compared to OFDMA and OFDM uplink transmissions because symbols in an SC-FDMA uplink transmissions are pre-processed using a DFT operation. Uplink transmissions using the single carrier modulation scheme as described with respect to the methods 600, 610 of FIG. 6 may also reduce design constraints on power amplifiers, such as the power amplifier 114 of FIG. 1.

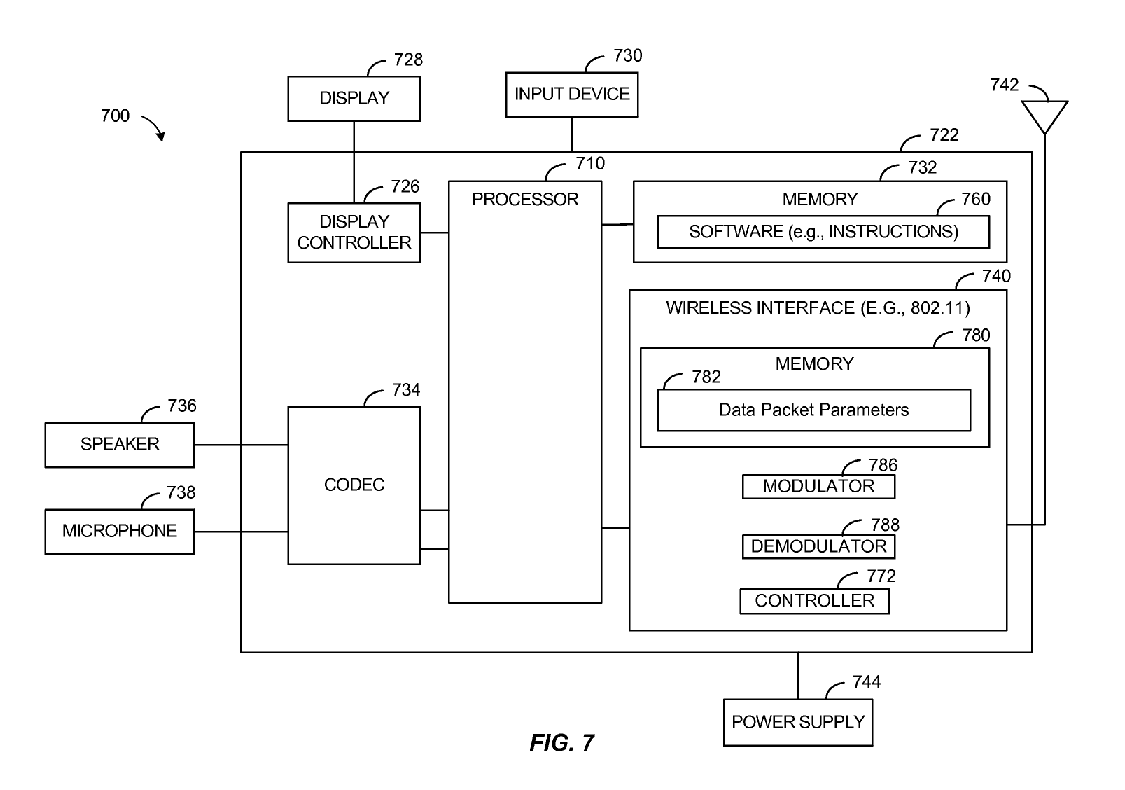

Referring to FIG. 7, a block diagram of a particular illustrative embodiment of a wireless communication device is depicted and generally designated 700. The device 700 includes a processor 710, such as a digital signal processor, coupled to a memory 732. In an illustrative embodiment, the device 700 may be the first source device 102 of FIG. 1, the second source device 116 of FIG. 1, the destination device 122 of FIG. 1, the source device 401 of FIG. 4, or the destination device 421 of FIG. 4.

The processor 710 may be configured to execute software 760 (e.g., a program of one or more instructions) stored in the memory 732. Additionally or alternatively, the processor 710 may be configured to implement one or more instructions stored in a memory 780 of a wireless interface 740 (e.g., an IEEE 802.11 wireless interface), as described further herein. In a particular embodiment, the processor 710 may be configured to operate in accordance with one or more of the methods 500, 510, 600, 610 of FIGS. 5-6. In a particular embodiment, the processor 710 may correspond to the processor 104 or 124 of FIG. 1, and the memory 732 may correspond to the memory 106 or 126 of FIG. 1.

The wireless interface 740 may be coupled to the processor 710 and to an antenna 742 such that wireless data received via the antenna 742 and the wireless interface 740 may be provided to the processor 710. For example, the wireless interface 740 may include or correspond to the wireless interface 110, 130 of FIG. 1. The wireless interface 740 may include the memory 780 and a controller 772. The memory 780 may include data packet parameters 782 (e.g., the data packet parameters 112 of FIG. 1). In a particular embodiment, the wireless interface 740 may also include a modulator 786 and a demodulator 788 for uplink and downlink communication, respectively, and may include one or more of the modules 402-414 of FIG. 4, one or more of the modules 416-428 of FIG. 4, or any combination thereof.

The controller 772 may be configured to interface with the processor 710 to execute one or more instructions stored in the memory 780. The controller 772 may also be configured to interface with the processor 710 to execute the modulator 786 and/or the demodulator 788. Additionally or alternatively, the controller 772 may include a processor configured to execute one or more of the instructions stored in the memory 780.

A coder/decoder (CODEC) 734 can also be coupled to the processor 710. A speaker 736 and a microphone 738 can be coupled to the CODEC 734. A display controller 726 can be coupled to the processor 710 and to a display 728. In a particular embodiment, the processor 710, the display controller 726, the memory 732, the CODEC 734, and the wireless interface 740, are included in a system-in-package or system-on-chip device 722. In a particular embodiment, an input device 730 and a power supply 744 are coupled to the system-on-chip device 722. Moreover, in a particular embodiment, as illustrated in FIG. 7, the display device 728, the input device 730, the speaker 736, the microphone 738, the antenna 742, and the power supply 744 are external to the system-on-chip device 722. However, each of the display device 728, the input device 730, the speaker 736, the microphone 738, the antenna 742, and the power supply 744 can be coupled to one or more components of the system-on-chip device 722, such as one or more interfaces or controllers.

In conjunction with the described embodiments, a first apparatus includes means for generating a data packet for transmission via an IEEE 802.11 wireless network. For example, the means for generating data packet may include the first source device 102 of FIG. 1, the processor 104 of FIG. 1, the memory 106 of FIG. 1, the packet generator 108 of FIG. 1, the wireless interface 110 of FIG. 1, the power amplifier 114 of FIG. 1, the second source device 116 of FIG. 1, the source device 401 of FIG. 4, the modulation symbol mapping module 402 of FIG. 4, the first transform module 404 of FIG. 4, the sub-carrier mapping module 406 of FIG. 4, the first inverse transform module 408 of FIG. 4, the cyclic prefix module 410 of FIG. 4, the P/S converter and DAC module 412 of FIG. 4, the RF modulation module 414 of FIG. 4, the wireless interface 740 of FIG. 7, the processor 710 programmed to execute the instructions 760 of FIG. 7, one or more other devices, circuits, modules, or instructions to generate the data packet, or any combination thereof.

The first apparatus also includes means for transmitting at least a portion of the data packet to a destination device according to a single carrier frequency division multiple access (SC-FDMA) modulation scheme. For example, the means for transmitting the portion of the data packet may include the first source device 102 of FIG. 1, the wireless interface 110 of FIG. 1, the source device 401 of FIG. 1, the wireless interface 740 of FIG. 7, the processor 710 programmed to execute the instructions 760 of FIG. 7, one or more other devices, circuits, modules, or instructions to transmit the portion the data packet, or any combination thereof.

In conjunction with the described embodiments, a second apparatus includes means for generating a data packet for uplink transmission via an IEEE 802.11 wireless network. For example, the means for generating data packet may include the first source device 102 of FIG. 1, the processor 104 of FIG. 1, the memory 106 of FIG. 1, the packet generator 108 of FIG. 1, the wireless interface 110 of FIG. 1, the power amplifier 114 of FIG. 1, the second source device 116 of FIG. 1, the source device 401 of FIG. 4, the modulation symbol mapping module 402 of FIG. 4, the first transform module 404 of FIG. 4, the sub-carrier mapping module 406 of FIG. 4, the first inverse transform module 408 of FIG. 4, the cyclic prefix module 410 of FIG. 4, the P/S converter and DAC module 412 of FIG. 4, the RF modulation module 414 of FIG. 4, the wireless interface 740 of FIG. 7, the processor 710 programmed to execute the instructions 760 of FIG. 7, one or more other devices, circuits, modules, or instructions to generate the data packet, or any combination thereof.

The second apparatus also includes means for transmitting at least a portion of the data packet to a destination device according to a single carrier modulation scheme. For example, the means for transmitting the portion of the data packet may include the first source device 102 of FIG. 1, the wireless interface 110 of FIG. 1, the source device 401 of FIG. 1, the wireless interface 740 of FIG. 7, the processor 710 programmed to execute the instructions 760 of FIG. 7, one or more other devices, circuits, modules, or instructions to transmit the portion of the data packet, or any combination thereof. In this embodiment, downlink transmission from the destination device may be received via the IEEE 802.11 wireless network according to a multi-carrier modulation scheme.

In conjunction with the described embodiments, a third apparatus includes means for receiving at least a portion of a data packet from a source device according to a SC-FDMA modulation scheme. The data packet is received via an IEEE 802.11 wireless network. For example, the means for receiving the data packet may include the destination device 122 of FIG. 1, the wireless interface 130 of FIG. 1, the destination device 421 of FIG. 4, the wireless interface 740 of FIG. 7, the processor 710 programmed to execute the instructions 760 of FIG. 7, one or more other devices, circuits, modules, or instructions to receive the portion of the data packet, or any combination thereof.

The third apparatus also includes means for processing the data packet. For example, the means for processing the data packet may include the destination device 122 of FIG. 1, the processor 124 of FIG. 1, the memory 126 of FIG. 1, the destination device 421 of FIG. 4, the RF demodulation module 416 of FIG. 4, the ADC and S/P converter module 418 of FIG. 4, the cyclic prefix remover module 420 of FIG. 4, the second transform module 422 of FIG. 4, the sub-carrier de-mapping module 424 of FIG. 4, the equalizer 426 of FIG. 4, the detector 428 of FIG. 4, the wireless interface 740 of FIG. 7, the processor 710 programmed to execute the instructions 760 of FIG. 7, one or more other devices, circuits, modules, or instructions to process the data packet, or any combination thereof.

In conjunction with the described embodiments, a fourth apparatus includes means for receiving an uplink transmission from a source device. In this embodiment, the uplink transmission includes at least a portion of a data packet that is received according to a single carrier modulation scheme. The data packet is received via an IEEE 802.11 wireless network. For example, the means for receiving an uplink transmission may include the destination device 122 of FIG. 1, the wireless interface 130 of FIG. 1, the destination device 421 of FIG. 4, the wireless interface 740 of FIG. 7, the processor 710 programmed to execute the instructions 760 of FIG. 7, one or more other devices, circuits, modules, or instructions to receive the uplink transmission, or any combination thereof.

The fourth apparatus also includes means for processing the data packet. For example, the means for processing the data packet may include the destination device 122 of FIG. 1, the processor 124 of FIG. 1, the memory 126 of FIG. 1, the destination device 421 of FIG. 4, the RF demodulation module 416 of FIG. 4, the ADC and S/P converter module 418 of FIG. 4, the cyclic prefix remover module 420 of FIG. 4, the second transform module 422 of FIG. 4, the sub-carrier de-mapping module 424 of FIG. 4, the equalizer 426 of FIG. 4, the detector 428 of FIG. 4, the wireless interface 740 of FIG. 7, the processor 710 programmed to execute the instructions 760 of FIG. 7, one or more other devices, circuits, modules, or instructions to process the data packet, or any combination thereof. In this embodiment, downlink transmissions are transmitted via the IEEE 802.11 wireless network according to a multi-carrier modulation scheme.

Those of skill would further appreciate that the various illustrative logical blocks, configurations, modules, circuits, and algorithm steps described in connection with the embodiments disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A method comprising:
generating, at a source device, a data packet for transmission via an Institute of Electrical and Electronics Engineers (IEEE) 802.11 wireless network; and
transmitting at least a portion of the data packet to a destination device according to a single carrier frequency division multiple access (SC-FDMA) modulation scheme.

2. The method of claim 1, wherein the transmission corresponds to an uplink transmission.

3. The method of claim 1, wherein the transmitting the at least the portion of the data packet comprises transmitting the at least the portion of the data packet over a first plurality of sub-carriers, wherein each sub-carrier of the first plurality of sub-carriers is allocated to the source device.

4. The method of claim 3, wherein one or more additional sub-carriers are allocated to one or more additional source devices.

5. The method of claim 4, wherein the sub-carriers of the first plurality of sub-carriers are interleaved with the sub-carriers of the one or more additional sub-carriers.

6. The method of claim 4, wherein each sub-carrier of the first plurality of sub-carriers is within a particular frequency band, and wherein the one or more additional sub-carriers are within one or more other frequency bands that do not overlap the particular frequency band.

7. The method of claim 1, wherein a preamble of the data packet comprises a legacy short training field, a legacy long training field, and a legacy signal field.

8. The method of claim 7, wherein the legacy short training field is transmitted according to an orthogonal frequency division multiplexing (OFDM) scheme to prevent additional source devices from transmitting on a carrier frequency associated with the data packet.

9. The method of claim 1, wherein a preamble of the data packet comprises a high efficiency short training field, a high efficiency long training field, and a high efficiency signal field.

10. The method of claim 1, wherein the generating the data packet comprises:
performing a transform operation on data symbols to generate transform coefficients; and
mapping each transform coefficient to a sub-carrier.

11. The method of claim 10, wherein the transform operation corresponds to a Discrete Fourier Transform (DFT) operation.

12. An apparatus comprising:
a memory; and
a processor coupled to the memory, the processor operable to:
generate a data packet for transmission via an Institute of Electrical and Electronics Engineers (IEEE) 802.11 wireless network; and
transmit at least a portion of the data packet to a destination device according to a single carrier frequency division multiple access (SC-FDMA) modulation scheme,
wherein the memory and the processor are included in a source device.

13. The apparatus of claim 12, wherein the transmission corresponds to an uplink transmission.

14. The apparatus of claim 12, wherein the processor is operable to transmit the at least the portion of the data packet over a first plurality of sub-carriers, wherein each sub-carrier of the first plurality of sub-carriers is allocated to the source device.

15. The apparatus of claim 14, wherein one or more additional sub-carriers are allocated to one or more additional source devices.

16. A method comprising:
generating, at a source device, a data packet for an uplink transmission via an Institute of Electrical and Electronics Engineers (IEEE) 802.11 wireless network; and
transmitting at least a portion of the data packet to a destination device according to a single carrier modulation scheme, wherein downlink transmissions from the destination device are received at the source device via the IEEE 802.11 wireless network according to a multi-carrier modulation scheme.

17. The method of claim 16, wherein the single carrier modulation scheme corresponds to a single carrier frequency division multiple access (SC-FDMA) modulation scheme.

18. The method of claim 16, wherein the transmitting the at least the portion of the data packet comprises transmitting the at least the portion of the data packet over a first plurality of sub-carriers, wherein each sub-carrier of the first plurality of sub-carriers is allocated to the source device.

19. The method of claim 18, wherein one or more additional sub-carriers are allocated to one or more additional source devices.

20. The method of claim 19, wherein the sub-carriers of the first plurality of sub-carriers are interleaved with the sub-carriers of the one or more additional sub-carriers.

21. The method of claim 19, wherein each sub-carrier of the first plurality of sub-carriers is within a particular frequency band, and wherein the one or more additional sub-carriers are within one or more other frequency bands that do not overlap the particular frequency band.

22. The method of claim 16, wherein a preamble of the data packet comprises a legacy short training field, a legacy long training field, and a legacy signal field.

23. The method of claim 22, wherein the legacy short training field is transmitted according to an orthogonal frequency division multiplexing (OFDM) scheme to prevent additional source devices from transmitting on a carrier frequency associated with the data packet.

24. The method of claim 16, wherein a preamble of the data packet comprises a high efficiency short training field, a high efficiency long training field, and a high efficiency signal field.

25. The method of claim 16, wherein the generating the data packet comprises:
performing a transform operation on data symbols to generate transform coefficients; and
mapping each transform coefficient to a sub-carrier.

26. The method of claim 25, wherein the transform operation corresponds to a Discrete Fourier Transform (DFT) operation.

27. An apparatus comprising:
a memory; and
a processor coupled to the memory, the processor operable to:
generate a data packet for an uplink transmission via an Institute of Electrical and Electronics Engineers (IEEE) 802.11 wireless network; and
transmit at least a portion of the data packet to a destination device according to a single carrier modulation scheme, wherein the memory and the processor are included in a source device, and wherein downlink transmissions from the destination device are received at the source device via the IEEE 802.11 wireless network according to a multi-carrier modulation scheme.

28. The apparatus of claim 27, wherein the single carrier modulation scheme corresponds to a single carrier frequency division multiple access (SC-FDMA) modulation scheme.

29. The apparatus of claim 27, wherein the processor is operable to transmit the at least the portion of the data packet over a first plurality of sub-carriers, wherein each sub-carrier of the first plurality of sub-carriers is allocated to the source device.

30. The apparatus of claim 29, wherein one or more additional sub-carriers are allocated to one or more additional source devices.
